(19) United States
(12) Patent Application Publication
(10) Pub. No.: US 2024/0088794 A1
(43) Pub. Date: Mar. 14, 2024

(54) DC-DC CONVERTER AND VEHICLE

(71) Applicant: Panasonic Intellectual Property Management Co., Ltd., Osaka (JP)

(72) Inventors: Hiroyuki HOSOI, Osaka (JP); Hideki NAKATA, Osaka (JP)

(21) Appl. No.: 18/517,386

(22) Filed: Nov. 22, 2023

Related U.S. Application Data
(63) Continuation of application No. PCT/JP2022/001189, filed on Jan. 14, 2022.

(30) Foreign Application Priority Data
Jun. 14, 2021 (JP) 2021-098936

(51) Int. Cl. H02M 3/335

(52) U.S. Cl. CPC H02M 3/33573; H02M 3/33576

(57) ABSTRACT

A DC-DC converter includes: a DC-AC conversion circuit that converts a DC input voltage into a primary AC voltage; a transformer including a primary coil to which the primary AC voltage is applied and generates a secondary AC voltage at a secondary coil; a rectifier circuit that outputs a rectified voltage obtained by full-wave rectifying the secondary AC voltage; a smoothing circuit that smooths the rectified voltage; and a control circuit that causes the rectifier circuit to perform rectification by a diode such that, in a free-wheeling period in which power of the input voltage is not transmitted to the transformer, a current does not flow via the rectifier circuit from a first intermediate terminal to a second intermediate terminal, the first and second intermediate terminals connected to the smoothing circuit, and a current flows via the rectifier circuit from the second intermediate terminal to the first intermediate terminal.

### CROSS-REFERENCE TO RELATED APPLICATIONS

This application is a continuation of International Application No. PCT/JP2022/001189, filed on Jan. 14, 2022 which claims the benefit of priority of the prior Japanese Patent Application No. 2021-098936, filed on Jun. 14, 2021, the entire contents of which are incorporated herein by reference.

### FIELD

The present disclosure relates to a DC-DC converter and a vehicle.

### BACKGROUND

An isolated DC-DC converter using a transformer is known. Such a DC-DC converter is used, for example, in an in-vehicle charger for charging a lead-acid battery with power of an in-vehicle lithium-ion battery. The DC-DC converter used in the in-vehicle charger converts, for example, a DC voltage of about 360 V of a lithium ion battery into a DC voltage of about 14 V. JP 2019-161992 A describes a DC-DC converter using a transformer.

In the DC-DC converter, a ratio between a transmission period in which power on an input side is transmitted to an output side and a free-wheeling period in which the power on the input side is not transmitted to the output side is adjusted according to a deviation of an output voltage or an output current with respect to a target voltage or a target current. That is, the DC-DC converter increases the ratio of the transmission period when the deviation is negative, and increases the ratio of the free-wheeling period when the deviation is positive.

In addition, for example, a DC-DC converter used in an in-vehicle charger often performs synchronous rectification using a switch element on a secondary side of a transformer. The synchronous rectification type DC-DC converter turns on the switch element in a period in which a current flows, so that a conduction loss can be suppressed as compared with a diode rectification type using only a diode on the secondary side.

In addition, in a full-bridge synchronous rectification type DC-DC converter, in the free-wheeling period, all metal oxide semiconductor field effect transistors (MOSFETs) constituting full-bridge switching elements on the secondary side are turned on, and an internal closed circuit is formed between a smoothing circuit of an output stage and the full-bridge switching element on the secondary side. As a result, the full-bridge synchronous rectification type DC-DC converter causes a free-wheeling current to flow through the internal closed circuit in the free-wheeling period, and holds the output current supplied from the smoothing circuit to a load so as to be constant.

Meanwhile, in the full-bridge synchronous rectification type DC-DC converter, in a case of a light load, that is, when the output current output from the smoothing circuit to the outside is small, a free-wheeling current in the reverse direction flows from the smoothing circuit to the full-bridge switch element on the secondary side in the free-wheeling period. In the full-bridge type DC-DC converter, each MOSFET constituting a full bridge has a drain connected to a high potential side of the smoothing circuit and a source connected to a low potential side of the smoothing circuit. Therefore, in the case of a light load, a current flows in a direction from the drain to the source in each MOSFET constituting the full bridge.

However, when switching is performed in a state in which the current flows in the direction from the drain to the source, each MOSFET constituting the full bridge is subjected to hard switching and generates a large switching loss. In addition, when such switching is performed, the MOSFET is greatly damaged.

In order to eliminate the switching loss due to such hard switching, the conventional full-bridge DC-DC converter turns off all of the MOSFETs in advance in the case of a light load, and performs diode rectification by a body diode instead of synchronous rectification. With this, the conventional full-bridge DC-DC converter blocks the free-wheeling current of the body diode in the reverse direction, and therefore, the hard switching of the MOSFET can be eliminated.

However, in the conventional full-bridge DC-DC converter, when diode rectification is performed with all of the MOSFETs turned off in this manner, a current flows via two body diodes connected in series, so that loss is very large. Therefore, the conventional DC-DC converter cannot efficiently perform electrical power conversion at the time of a light load.

### SUMMARY

A DC-DC converter according to the present disclosure includes a DC-AC conversion circuit, a transformer, a rectifier circuit, a smoothing circuit, and a control circuit. The DC-AC conversion circuit converts a DC input voltage into a primary AC voltage by performing switching to reverse polarity of the DC input voltage. The transformer includes a primary coil, and a secondary coil. The primary AC voltage is applied to the primary coil. The secondary coil is magnetically coupled to the primary coil. The transformer generates a secondary AC voltage at the secondary coil. The rectifier circuit outputs a rectified voltage obtained by full-wave rectifying the secondary AC voltage. The smoothing circuit outputs a DC output voltage obtained by smoothing the rectified voltage. The control circuit controls operation of the DC-AC conversion circuit and the rectifier circuit. The control circuit causes the rectifier circuit to perform rectification by a diode such that, in a free-wheeling period in which power of the input voltage is not transmitted from the DC-AC conversion circuit to the transformer, a current does not flow via the rectifier circuit from a first intermediate terminal, which is one intermediate terminal connected to the smoothing circuit, to a second intermediate terminal connected to the smoothing circuit and opposite to the first intermediate terminal, and a current flows via the rectifier circuit from the second intermediate terminal to the first intermediate terminal.

### BRIEF DESCRIPTION OF THE DRAWINGS

FIG. 1 is a diagram illustrating a configuration of a DC-DC converter according to an embodiment;

FIG. 2 is a diagram illustrating a configuration of a DC-AC conversion circuit and control signals supplied from a control circuit to the DC-AC conversion circuit;

FIG. 3 is a timing chart of the control signals supplied to the DC-AC conversion circuit;

FIG. 4 is a diagram illustrating a configuration of a rectifier circuit and control signals supplied from the control circuit to the DC-AC conversion circuit;

FIG. 5 is a diagram illustrating a switching state of the rectifier circuit in a first transmission period;

FIG. 6 is a diagram illustrating the switching state of the rectifier circuit in a second transmission period;

FIG. 7 is a diagram illustrating a first example of the switching state of the rectifier circuit in a free-wheeling period;

FIG. 8 is a diagram illustrating a second example of the switching state of the rectifier circuit in the free-wheeling period;

FIG. 9 is a diagram illustrating a third example of the switching state of the rectifier circuit in the free-wheeling period;

FIG. 10 is a diagram illustrating a fourth example of the switching state of the rectifier circuit in the free-wheeling period;

FIG. 11 is a diagram illustrating a fifth example of the switching state of the rectifier circuit in the free-wheeling period;

FIG. 12 is a diagram illustrating a sixth example of the switching state of the rectifier circuit in the free-wheeling period;

FIG. 13 is a schematic waveform chart of a voltage and a current when synchronous switching is performed in the transmission period and all switch elements are turned on in the free-wheeling period in a state where a heavy load is connected;

FIG. 14 is a schematic waveform chart of the voltage and the current when synchronous switching is performed in the transmission period and all of the switch elements are turned on in the free-wheeling period in a state where a light load is connected;

FIG. 15 is a schematic waveform chart of a voltage and a current of the DC-DC converter according to the present embodiment in a state where a light load is connected;

FIG. 16 is a flowchart illustrating setting processing for a mode;

FIG. 17 is a timing chart of control signals in a first mode;

FIG. 18 is a timing chart of the control signals in a second mode;

FIG. 19 is a diagram illustrating a waveform of a reference signal for generating a control signal on a secondary side;

FIG. 20 is a diagram illustrating a configuration of a logic circuit for generating the control signal on the secondary side; and

FIG. 21 is a diagram illustrating a configuration of a vehicle.

### DETAILED DESCRIPTION

Hereinafter, an embodiment of a DC-DC converter 10 according to the present disclosure will be described with reference to the drawings.

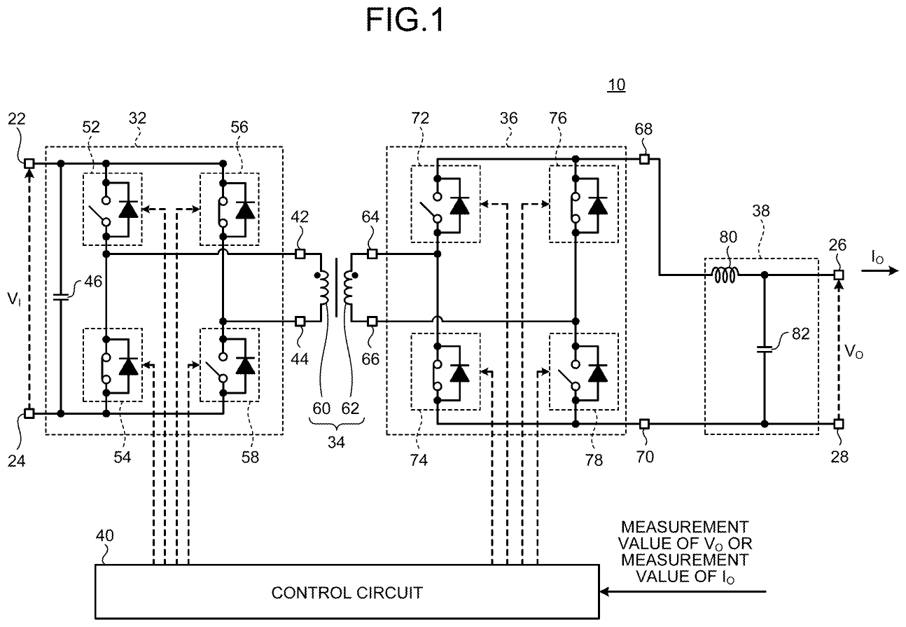

FIG. 1 is a diagram illustrating a configuration of the DC-DC converter 10 according to a first embodiment. The DC-DC converter 10 is a power conversion device that receives a DC input voltage V_{I} from a preceding device, converts the received DC input voltage V_{I} into a DC output voltage V_{O}, and supplies the output voltage V_{O} to a subsequent device. In the present embodiment, the DC-DC converter 10 outputs the DC output voltage V_{O} obtained by stepping down the DC input voltage V_{I}. The DC-DC converter 10 may output the DC output voltage V_{O} obtained by boosting the DC input voltage V_{I}.

The DC-DC converter 10 includes a first input terminal 22, a second input terminal 24, a first output terminal 26, a second output terminal 28, a DC-AC conversion circuit 32, a transformer 34, a rectifier circuit 36, a smoothing circuit 38, and a control circuit 40.

The DC-DC converter 10 receives the DC input voltage V_{I} from the preceding device between the first input terminal 22 and the second input terminal 24. A voltage higher than that of the second input terminal 24 is applied to the first input terminal 22. Note that each of the first input terminal 22 and the second input terminal 24 may be a cable, wiring, or the like connected to the preceding device.

The DC-DC converter 10 outputs the DC output voltage V_{O} from between the first output terminal 26 and the second output terminal 28 to the subsequent device. The first output terminal 26 generates a voltage higher than that of the second output terminal 28. Note that each of the first output terminal 26 and the second output terminal 28 may be a cable, wiring, or the like connected to the subsequent device.

The DC-AC conversion circuit 32 converts, by performing switching to reverse the polarity of the DC input voltage V_{I} applied between the first input terminal 22 and the second input terminal 24, the input voltage into a primary AC voltage. Then, the DC-AC conversion circuit 32 outputs the primary AC voltage between a first AC terminal 42 and a second AC terminal 44. A waveform of the primary AC voltage may be a pulse waveform.

The DC-AC conversion circuit 32 is a full-bridge type converter. In a case of the full-bridge type converter, the DC-AC conversion circuit 32 includes a conversion capacitor 46, a first conversion switch 52, a second conversion switch 54, a third conversion switch 56, and a fourth conversion switch 58. The first conversion switch 52, the second conversion switch 54, the third conversion switch 56, and the fourth conversion switch 58 are semiconductor elements such as metal-oxide semiconductor field-effect transistors (MOSFETs) that switch a power line between conduction and disconnection according to control from the control circuit 40.

The conversion capacitor 46 is connected between the first input terminal 22 and the second input terminal 24. Note that the conversion capacitor 46 may be provided outside an input side of the DC-AC conversion circuit 32.

The first conversion switch 52 is connected between the first input terminal 22 and the first AC terminal 42. The second conversion switch 54 is connected between the second input terminal 24 and the first AC terminal 42. The third conversion switch 56 is connected between the first input terminal 22 and the second AC terminal 44. The fourth conversion switch 58 is connected between the second input terminal 24 and the second AC terminal 44. The first conversion switch 52, the second conversion switch 54, the third conversion switch 56, and the fourth conversion switch 58 are subjected to switching control by the control circuit such that the primary AC voltage is generated between the first AC terminal 42 and the second AC terminal 44. As a result, the DC-AC conversion circuit 32 can convert the DC input voltage V_{I} into the primary AC voltage.

The transformer 34 includes a primary coil 60 and a secondary coil 62.

The primary coil 60 is connected between the first AC terminal 42 and the second AC terminal 44. The secondary coil 62 is magnetically coupled to the primary coil 60. The secondary coil 62 outputs a secondary AC voltage based on the primary AC voltage. Therefore, the transformer 34 generates the secondary AC voltage in the secondary coil 62 with the primary AC voltage applied to the primary coil 60.

In addition, the transformer 34 includes a first transformer output terminal 64 and a second transformer output terminal 66. The first transformer output terminal 64 is connected to one terminal of the secondary coil 62. The second transformer output terminal 66 is connected to a terminal of the secondary coil 62 on a side opposite to the terminal to which the first transformer output terminal 64 is connected. Therefore, the transformer 34 generates the secondary AC voltage between the first transformer output terminal 64 and the second transformer output terminal 66.

The rectifier circuit 36 performs full-wave rectification of the secondary AC voltage output from the secondary coil 62. Then, the rectifier circuit 36 outputs a rectified voltage obtained by full-wave rectifying the secondary AC voltage output from the secondary coil 62. The rectifier circuit 36 outputs the rectified voltage between a first intermediate terminal 68 and a second intermediate terminal 70.

The rectifier circuit 36 performs full-bridge synchronous full-wave rectification. More specifically, the rectifier circuit 36 includes a first switch element 72, a second switch element 74, a third switch element 76, and a fourth switch element 78. The first switch element 72, the second switch element 74, the third switch element 76, and the fourth switch element 78 are, for example, semiconductor elements that are switched on or off according to control from the control circuit 40.

Each of the first switch element 72, the second switch element 74, the third switch element 76, and the fourth switch element 78 brings the power line into conduction when turned on. In addition, each of the first switch element 72, the second switch element 74, the third switch element 76, and the fourth switch element 78 functions as a diode when turned off.

In the present embodiment, the first switch element 72, the second switch element 74, the third switch element 76, and the fourth switch element 78 are MOSFETs. The MOSFET includes a body diode in which a direction from a source to a drain is a forward direction. That is, the MOSFET functions as a switch that establishes conduction or non-conduction between the source and the drain, and also functions as a diode whose anode is connected to the source and whose cathode is connected to the drain when the MOSFET is turned off. Therefore, when a source potential is higher than a drain potential in an OFF time, the MOSFET conducts to allow a current to flow, and when the source potential is lower than the drain potential, the MOSFET does not conduct and not allow a current to flow.

The first switch element 72 is connected between the first transformer output terminal 64 and the first intermediate terminal 68. In a case of a MOSFET, the first switch element 72 has a source connected to the first transformer output terminal 64 and a drain connected to the first intermediate terminal 68. Therefore, in the first switch element 72, which is a MOSFET, an anode of the body diode is connected to the first transformer output terminal 64, and a cathode of the body diode is connected to the first intermediate terminal 68.

The second switch element 74 is connected between the second intermediate terminal 70 and the first transformer output terminal 64. In the case of a MOSFET, the second switch element 74 has a source connected to the second intermediate terminal 70 and a drain connected to the first transformer output terminal 64. Therefore, in the second switch element 74, which is a MOSFET, an anode of the body diode is connected to the second intermediate terminal 70, and a cathode of the body diode is connected to the first transformer output terminal 64.

The third switch element 76 is connected between the second transformer output terminal 66 and the first intermediate terminal 68. In the case of a MOSFET, the third switch element 76 has a source connected to the second transformer output terminal 66 and a drain connected to the first intermediate terminal 68. Therefore, in the third switch element 76, which is a MOSFET, an anode of the body diode is connected to the second transformer output terminal 66, and a cathode of the body diode is connected to the first intermediate terminal 68.

The fourth switch element 78 is connected between the second intermediate terminal 70 and the second transformer output terminal 66. In the case of a MOSFET, the fourth switch element 78 has a source connected to the second intermediate terminal 70 and a drain connected to the second transformer output terminal 66. Therefore, in the fourth switch element 78, which is a MOSFET, an anode of the body diode is connected to the second intermediate terminal 70, and a cathode of the body diode is connected to the second transformer output terminal 66.

In addition, when each of the first switch element 72, the second switch element 74, the third switch element 76, and the fourth switch element 78 is a MOSFET, a control signal from the control circuit 40 is applied to a gate. Therefore, the first switch element 72, the second switch element 74, the third switch element 76, and the fourth switch element 78 are switched on or off by the control signal from the control circuit 40.

The smoothing circuit 38 smooths the rectified voltage output from the rectifier circuit 36. For example, the smoothing circuit 38 may be an LC type low-pass filter including a smoothing inductor 80 and a smoothing capacitor 82. In this case, the smoothing inductor 80 and the smoothing capacitor 82 are connected in series between the first intermediate terminal 68 and the second intermediate terminal 70. Then, in this case, the smoothing circuit 38 outputs a voltage across both ends of the smoothing capacitor 82 as a voltage obtained by smoothing the rectified voltage.

The first output terminal 26 is connected to a terminal of the smoothing capacitor 82 included in the smoothing circuit 38 on a side connected to the smoothing inductor 80. In addition, for example, the second output terminal 28 is connected to a terminal of the smoothing capacitor 82 included in the smoothing circuit 38 on a side not connected to the smoothing inductor 80. Then, the first output terminal 26 and the second output terminal 28 output the DC output voltage V_{O} to the subsequent device.

The control circuit 40 includes, for example, a central processing unit (CPU), a read only memory (ROM), and a random access memory (RAM). The control circuit 40 executes processing on the basis of a program set in advance. For example, the control circuit 40 generates the control signal by cooperation of, for example, a processor such as a CPU and a program (software) stored in a ROM or the like. Note that the function of the control circuit 40 is not limited to that realized by software, and may be a circuit including a logic circuit or the like, or may be realized by a hardware configuration such as a dedicated circuit.

The control circuit 40 acquires a measurement value of the output voltage V_{O} output between the first output terminal 26 and the second output terminal 28 or a measurement value of an output current I_{O} supplied to a load to which the output voltage V_{O} is applied. The control circuit 40 calculates a deviation between the measurement value of the output voltage V_{O} and a target voltage or a deviation between the measurement value of the output current I_{O} and a target current. Then, the control circuit 40 controls a ratio between the transmission period and the free-wheeling period so as to reduce the calculated deviation.

For example, the control circuit 40 performs switching control of the DC-AC conversion circuit 32 so as to change the ratio between the transmission period and the free-wheeling period according to the calculated deviation. For example, the control circuit 40 controls on and off of the first conversion switch 52, the second conversion switch 54, the third conversion switch 56, and the fourth conversion switch 58 according to the deviation between the measurement value of the output voltage V_{O} and the target voltage or the deviation between the measurement value of the output current I_{O} and the target current.

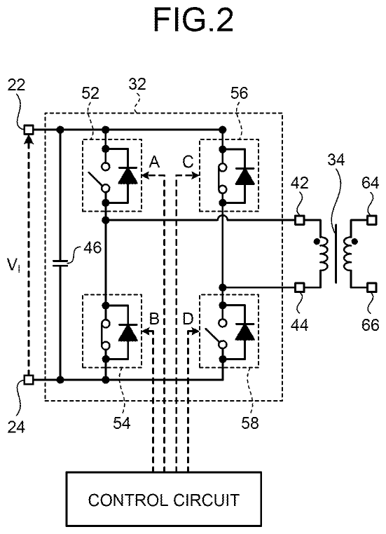

FIG. 2 is a diagram illustrating a configuration of the DC-AC conversion circuit 32 and control signals supplied from the control circuit 40 to the DC-AC conversion circuit 32. In the present embodiment, the control circuit 40 supplies a control signal (A) for turning on/off the first conversion switch 52, a control signal (B) for turning on/off the second conversion switch 54, a control signal (C) for turning on/off the third conversion switch 56, and a control signal (D) for turning on/off the fourth conversion switch 58 to the DC-AC conversion circuit 32.

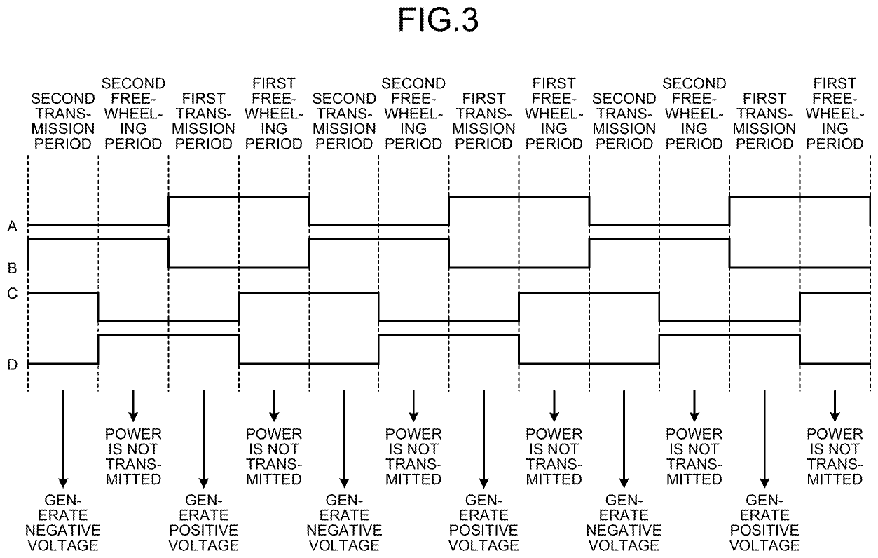

FIG. 3 is a timing chart of the control signals supplied to the DC-AC conversion circuit 32. More specifically, FIG. 3 is a timing chart of a control system of a phase-shift full-bridge converter in which the first conversion switch 52 and the second conversion switch 54 are used as a lagging leg and the third conversion switch 56 and the fourth conversion switch 58 are used as a leading leg. In addition, in FIG. 3, an on-duty of the first conversion switch 52, the second conversion switch 54, the third conversion switch 56, and the fourth conversion switch 58 is 0.5. However, a short period (dead time) may be provided in which both the first conversion switch 52 and the second conversion switch 54 are turned off so as to prevent power short-circuit with the first conversion switch 52 and the second conversion switch 54 simultaneously brought into an ON state when switching between the transmission period and the free-wheeling period. In that case, for example, the on-duty is set to 0.47. Note that a dead time may be similarly provided for the third conversion switch 56 and the fourth conversion switch 58.

The control circuit 40 controls the first conversion switch 52, the second conversion switch 54, the third conversion switch 56, and the fourth conversion switch 58 to perform sequential switching of a first transmission period, a first free-wheeling period, a second transmission period, and a second free-wheeling period.

Each of the first transmission period and the second transmission period is a transmission period in which the power of the DC input voltage V_{I} is transmitted from the DC-AC conversion circuit 32 to the transformer 34.

The first transmission period is a period in which a voltage having a first polarity, which is either positive or negative, is applied to the primary coil 60 of the transformer 34 to generate a positive secondary AC voltage from the secondary coil 62 of the transformer 34. That is, the first transmission period is a period in which a voltage higher than that of the second transformer output terminal 66 is generated from the first transformer output terminal 64.

The second transmission period is a period in which a voltage having a second polarity opposite to the first polarity, which is positive or negative, is applied to the primary coil 60 of the transformer 34 to generate a negative secondary AC voltage from the secondary coil 62 of the transformer 34. That is, the second transmission period is a period in which a voltage higher than that of the first transformer output terminal 64 is generated from the second transformer output terminal 66.

In the first transmission period, the control circuit 40 turns on the first conversion switch 52 and the fourth conversion switch 58 by setting the control signal (A) and the control signal (D) to logic H, and turns off the second conversion switch 54 and the third conversion switch 56 by setting the control signal (B) and the control signal (C) to logic L. As a result, the control circuit 40 can connect the first input terminal 22 to the first AC terminal 42 of the transformer 34 and connect the second input terminal 24 to the second AC terminal 44 of the transformer 34 in the first transmission period.

In the second transmission period, the control circuit turns on the second conversion switch 54 and the third conversion switch 56 by setting the control signal (B) and the control signal (C) to logic H, and turns off the first conversion switch 52 and the fourth conversion switch 58 by setting the control signal (A) and the control signal (D) to logic L. As a result, the control circuit 40 can connect the first input terminal 22 to the second AC terminal 44 of the transformer 34 and connect the second input terminal 24 to the first AC terminal 42 of the transformer 34 in the second transmission period.

Each of the first free-wheeling period and the second free-wheeling period is a free-wheeling period in which the power of the DC input voltage V_{I} is not transmitted from the DC-AC conversion circuit 32 to the transformer 34.

In the free-wheeling period, the control circuit 40 performs switching of the DC-AC conversion circuit 32 such that power is not supplied from the DC-AC conversion circuit 32 to the transformer 34, and a closed circuit including the primary coil 60 is formed. As a result, the control circuit can cause energy accumulated in the primary coil 60 to be held in the closed circuit in the free-wheeling period.

In the first free-wheeling period, for example, the control circuit 40 turns on the first conversion switch 52 and the third conversion switch 56 by setting the control signal (A) and the control signal (C) to logic H, and turns off the second conversion switch 54 and the fourth conversion switch 58 by setting the control signal (B) and the control signal (D) to logic L. As a result, the control circuit 40 can cause a closed circuit including the first conversion switch 52, the third conversion switch 56, and the primary coil 60 to be formed.

In the second free-wheeling period, for example, the control circuit 40 turns on the second conversion switch 54 and the fourth conversion switch 58 by setting the control signal (B) and the control signal (D) to logic H, and turns off the first conversion switch 52 and the third conversion switch 56 by setting the control signal (A) and the control signal (C) to logic L. As a result, the control circuit 40 can cause a closed circuit including the second conversion switch 54, the fourth conversion switch 58, and the primary coil 60 to be formed.

Then, the control circuit 40 controls the ratio between the transmission period and the free-wheeling period according to the deviation between the measurement value of the output voltage V_{O} and the target voltage or the deviation between the measurement value of the output current I_{O} and the target current. For example, the control circuit 40 performs control so as to increase the ratio of the transmission period when the deviation is negative, and to decrease the ratio of the transmission period when the deviation is positive. For example, the control circuit 40 controls the ratio between the transmission period and the free-wheeling period by changing a phase relationship between the signal A (and the signal B) and the signal C (and the signal D). Alternatively, the control circuit 40 may control the ratio between the transmission period and the free-wheeling period by fixing the phase relationship and changing a duty ratio of the signal A (and the signal B) or a duty ratio of the signal C (and the signal D). As a result, the control circuit 40 can set the output voltage V_{O} or the output current I_{O} to a target value.

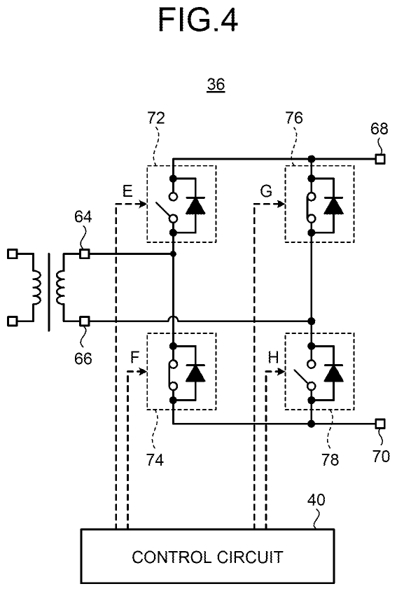

FIG. 4 is a diagram illustrating a configuration of the rectifier circuit 36 and control signals supplied from the control circuit 40 to the rectifier circuit 36.

The control circuit 40 performs switching of the first switch element 72, the second switch element 74, the third switch element 76, and the fourth switch element 78 included in the rectifier circuit 36 in synchronization with switching of the switch of the DC-AC conversion circuit 32. That is, in synchronization with switching of the first transmission period, the first free-wheeling period, the second transmission period, and the second free-wheeling period, the control circuit 40 performs switching of the first switch element 72, the second switch element 74, the third switch element 76, and the fourth switch element 78 according to an on/off pattern determined in advance for each period.

In the present embodiment, the control circuit 40 supplies a control signal (E) for turning on/off the first switch element 72, a control signal (F) for turning on/off the second switch element 74, a control signal (G) for turning on/off the third switch element 76, and a control signal (H) for turning on/off the fourth switch element 78 to the rectifier circuit 36. Note that in each of the control signals (E to F), a voltage for turning on the first switch element 72, the second switch element 74, the third switch element 76, and the fourth switch element 78 is logic H, and a voltage for turning off the first switch element 72, the second switch element 74, the third switch element 76, and the fourth switch element 78 is logic L.

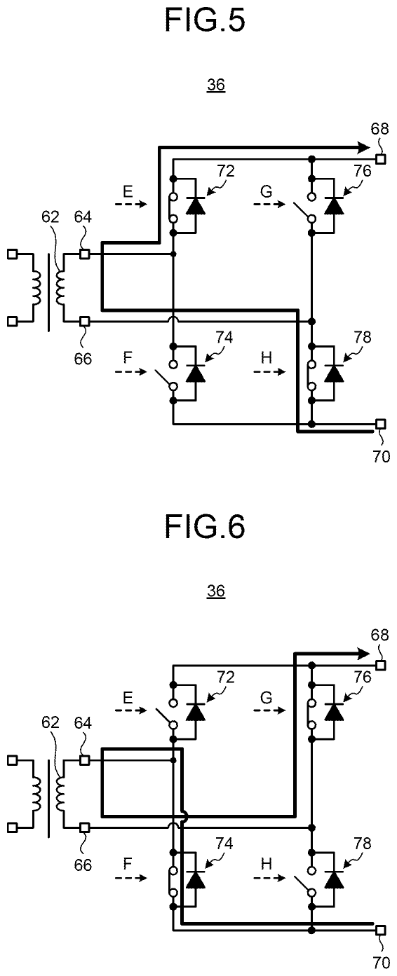

Here, in the transmission period, the control circuit 40 switches a connection between the secondary coil 62 and the first intermediate terminal 68 and a connection between the secondary coil 62 and the second intermediate terminal 70 in the rectifier circuit 36 in synchronization with the switching of the DC-AC conversion circuit 32 such that a positive side of the secondary AC voltage is applied to the first intermediate terminal 68 and a negative side of the secondary AC voltage is applied to the second intermediate terminal 70. Note that a specific switching pattern of the rectifier circuit 36 in the transmission period will be described later with reference to FIGS. 5 and 6.

In addition, in the free-wheeling period, the control circuit 40 causes the rectifier circuit 36 to perform rectification with a diode such that a current does not flow from the first intermediate terminal 68 to the second intermediate terminal 70 via the rectifier circuit 36 and a current flows from the second intermediate terminal 70 to the first intermediate terminal 68 via the rectifier circuit 36.

In the present embodiment, the diode is the body diode included in each of the first switch element 72, the second switch element 74, the third switch element 76, and the fourth switch element 78. In the present embodiment, the control circuit 40 performs switching of the first switch element 72, the second switch element 74, the third switch element 76, and the fourth switch element 78 such that a current flows through only one body diode in the rectifier circuit 36 in a direction from the second intermediate terminal 70 to the first intermediate terminal 68 and a current is blocked by a rectification function of the body diode in the rectifier circuit 36 in a direction from the first intermediate terminal 68 to the second intermediate terminal 70 in the free-wheeling period.

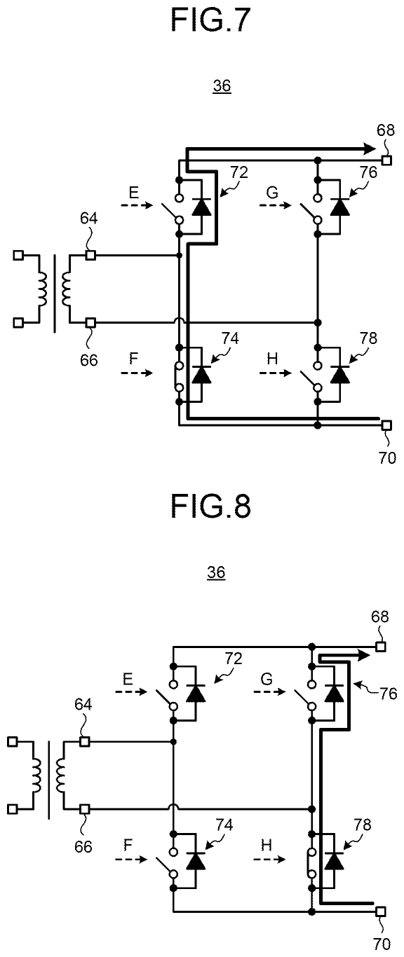

For example, in the free-wheeling period, the control circuit 40 turns off the first switch element 72 and the third switch element 76, and turns on at least one of the second switch element 74 and the fourth switch element 78. Alternatively, in the free-wheeling period, the control circuit 40 turns off the second switch element 74 and the fourth switch element 78, and turns on at least one of the first switch element 72 and the third switch element 76. Note that a specific switching pattern of the rectifier circuit 36 in the free-wheeling period will be described later with reference to FIGS. 7 to 12.

By controlling the rectifier circuit 36 in this manner, the control circuit 40 can eliminate a power loss caused by a current passing through the diode in the forward direction in the transmission period. Furthermore, the control circuit 40 can suppress a power loss due to hard switching by reducing a free-wheeling current in the reverse direction in the free-wheeling period, that is, the current flowing in the direction from the first intermediate terminal 68 to the second intermediate terminal 70 via the rectifier circuit 36 to 0. Furthermore, the control circuit 40 can cause the number of body diodes through which a free-wheeling current in the forward direction in the free-wheeling period, that is, the current flowing in the direction from the second intermediate terminal 70 to the first intermediate terminal 68 via the rectifier circuit 36 passes, to be one, and a power loss in the free-wheeling period can be reduced.

FIG. 5 is a diagram illustrating a switching state of the rectifier circuit 36 in the first transmission period. In the first transmission period, the control circuit 40 turns on the first switch element 72 and the fourth switch element 78 by setting the control signal (E) and the control signal (H) to logic H. Further, in the first transmission period, the control circuit 40 turns off the second switch element 74 and the third switch element 76 by setting the control signal (F) and the control signal (G) to logic L.

In the first transmission period, the transformer 34 generates a voltage higher than that of the second transformer output terminal 66 from the first transformer output terminal 64. Therefore, by performing such switching in the first transmission period, the control circuit 40 can apply the rectified voltage obtained by rectifying the secondary AC voltage between the first intermediate terminal 68 and the second intermediate terminal 70 by connecting the first transformer output terminal 64 to the first intermediate terminal 68 and connecting the second transformer output terminal 66 to the second intermediate terminal 70. As a result, the control circuit 40 can cause a current to flow from the second intermediate terminal 70 to the first intermediate terminal 68 via the secondary coil 62 without passing through the diode, so that a power loss can be eliminated.

FIG. 6 is a diagram illustrating the switching state of the rectifier circuit 36 in the second transmission period. In the second transmission period, the control circuit 40 turns on the second switch element 74 and the third switch element 76 by setting the control signal (F) and the control signal (G) to logic H. Further, in the second transmission period, the control circuit 40 turns off the first switch element 72 and the fourth switch element 78 by setting the control signal (E) and the control signal (H) to logic L.

In the second transmission period, the transformer 34 generates a voltage higher than that of the first transformer output terminal 64 from the second transformer output terminal 66. Therefore, by performing such switching in the second transmission period, the control circuit 40 can apply the rectified voltage obtained by rectifying the secondary AC voltage between the first intermediate terminal 68 and the second intermediate terminal 70 by connecting the second transformer output terminal 66 to the first intermediate terminal 68 and connecting the first transformer output terminal 64 to the second intermediate terminal 70. As a result, the control circuit 40 can cause a current to flow from the first intermediate terminal 68 to the second intermediate terminal 70 via the secondary coil 62 without passing through the diode, so that a power loss can be eliminated.

FIG. 7 is a diagram illustrating a first example of the switching state of the rectifier circuit 36 in the free-wheeling period. In the free-wheeling period (for example, the first free-wheeling period or the second free-wheeling period), as an example, the control circuit 40 turns off the first switch element 72, the third switch element 76, and the fourth switch element 78 by setting the control signal (E), the control signal (G), and the control signal (H) to logic L as illustrated in FIG. 7. Further, in the free-wheeling period, the control circuit 40 turns on the second switch element 74 by setting the control signal (F) to logic H.

As a result, in the free-wheeling period, the control circuit 40 can cause the free-wheeling current in the forward direction in the direction from the second intermediate terminal 70 to the first intermediate terminal 68 to flow via the body diode of the first switch element 72 and the second switch element 74 in the ON state. Then, the control circuit can block the free-wheeling current in the reverse direction from the first intermediate terminal 68 to the second intermediate terminal 70 by the rectification function of the body diodes of the first switch element 72 and the third switch element 76. By performing such switching, the control circuit 40 can causes the free-wheeling current in the reverse direction in the free-wheeling period to be 0, and eliminate the hard switching. Furthermore, since the control circuit 40 can cause the number of body diodes through which the free-wheeling current in the forward direction in the free-wheeling period passes, to be one, the power loss can be reduced.

FIG. 8 is a diagram illustrating a second example of the switching state of the rectifier circuit 36 in the free-wheeling period. In the free-wheeling period, as an example, the control circuit 40 turns off the first switch element 72, the second switch element 74, and the third switch element 76 by setting the control signal (E), the control signal (F), and the control signal (G) to logic L as illustrated in FIG. 8. Further, in the free-wheeling period, the control circuit turns on the fourth switch element 78 by setting the control signal (H) to logic H.

As a result, in the free-wheeling period, the control circuit 40 can cause the free-wheeling current in the forward direction in the direction from the second intermediate terminal 70 to the first intermediate terminal 68 to flow via the body diode of the third switch element 76 and the fourth switch element 78 in the ON state. Then, the control circuit can block the free-wheeling current in the reverse direction from the first intermediate terminal 68 to the second intermediate terminal 70 by the rectification function of the body diodes of the first switch element 72 and the third switch element 76. By performing such switching, the control circuit 40 can eliminate the hard switching by causing the free-wheeling current in the reverse direction in the free-wheeling period to be 0. Furthermore, since the control circuit 40 can cause the number of body diodes through which the free-wheeling current in the forward direction in the free-wheeling period passes, to be one, the power loss can be reduced.

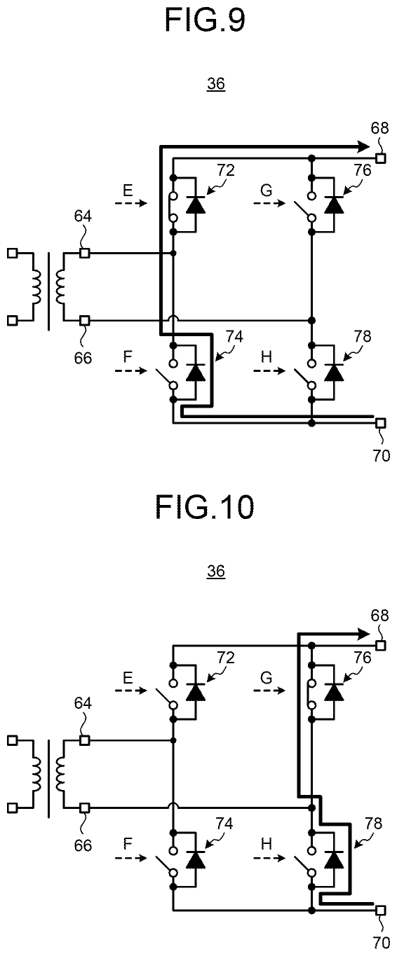

FIG. 9 is a diagram illustrating a third example of the switching state of the rectifier circuit 36 in the free-wheeling period. In the free-wheeling period, as an example, the control circuit 40 turns off the second switch element 74, the third switch element 76, and the fourth switch element 78 by setting the control signal (F), the control signal (G), and the control signal (H) to logic L as illustrated in FIG. 9. Further, in the free-wheeling period, the control circuit 40 turns on the first switch element 72 by setting the control signal (E) to logic H.

As a result, in the free-wheeling period, the control circuit 40 can cause the free-wheeling current in the forward direction in the direction from the second intermediate terminal 70 to the first intermediate terminal 68 to flow via the body diode of the second switch element 74 and the first switch element 72 in the ON state. Then, the control circuit can block the free-wheeling current in the reverse direction from the first intermediate terminal 68 to the second intermediate terminal 70 by the rectification function of the body diodes of the second switch element 74 and the fourth switch element 78. By performing such switching, the control circuit 40 can eliminate the hard switching by causing the free-wheeling current in the reverse direction in the free-wheeling period to be 0. Furthermore, since the control circuit 40 can cause the number of body diodes through which the free-wheeling current in the forward direction in the free-wheeling period passes, to be one, the power loss can be reduced.

FIG. 10 is a diagram illustrating a fourth example of the switching state of the rectifier circuit 36 in the free-wheeling period. In the free-wheeling period, as an example, the control circuit 40 turns off the first switch element 72, the second switch element 74, and the fourth switch element 78 by setting the control signal (E), the control signal (F), and the control signal (H) to logic L as illustrated in FIG. 10. Further, in the free-wheeling period, the control circuit 40 turns on the third switch element 76 by setting the control signal (G) to logic H.

As a result, in the free-wheeling period, the control circuit 40 can cause the free-wheeling current in the forward direction in the direction from the second intermediate terminal 70 to the first intermediate terminal 68 to flow via the body diode of the fourth switch element 78 and the third switch element 76 in the ON state. Then, the control circuit can block the free-wheeling current in the reverse direction from the first intermediate terminal 68 to the second intermediate terminal 70 by the rectification function of the body diodes of the second switch element 74 and the fourth switch element 78. By performing such switching, the control circuit 40 can eliminate the hard switching by causing the free-wheeling current in the reverse direction in the free-wheeling period to be 0. Furthermore, since the control circuit 40 can cause the number of body diodes through which the free-wheeling current in the forward direction in the free-wheeling period passes, to be one, the power loss can be reduced.

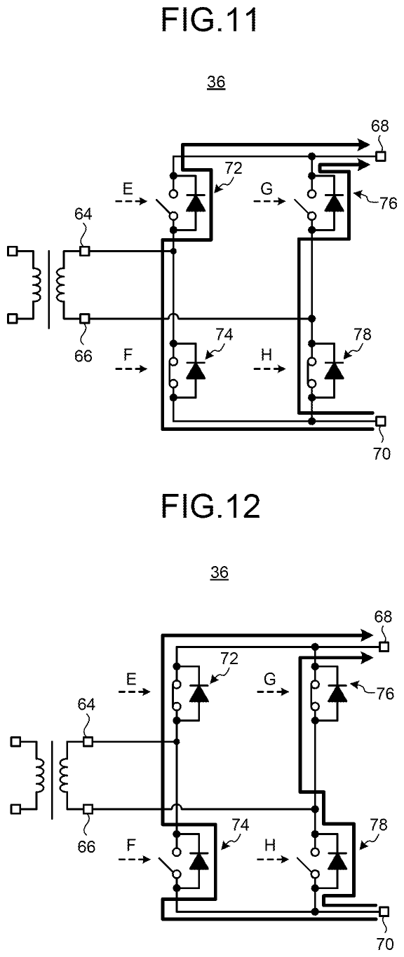

FIG. 11 is a diagram illustrating a fifth example of the switching state of the rectifier circuit 36 in the free-wheeling period. In the free-wheeling period, as an example, the control circuit 40 turns off the first switch element 72 and the third switch element 76 by setting the control signal (E) and the control signal (G) to logic L as illustrated in FIG. 11. Further, in the free-wheeling period, the control circuit 40 turns on the second switch element 74 and the fourth switch element 78 by setting the control signal (F) and the control signal (H) to logic H.

As a result, in the free-wheeling period, the control circuit 40 can cause the free-wheeling current in the forward direction in the direction from the second intermediate terminal 70 to the first intermediate terminal 68 to flow via the body diode of the first switch element 72 and the second switch element 74 in the ON state, or the body diode of the third switch element 76 and the fourth switch element 78 in the ON state. Note that the free-wheeling current in the forward direction theoretically flows while being distributed to two paths, but actually flows in one of the paths due to a difference in balance of resistance values.

Then, the control circuit 40 can block the free-wheeling current in the reverse direction from the first intermediate terminal 68 to the second intermediate terminal 70 by the rectification function of the body diodes of the first switch element 72 and the third switch element 76. By performing such switching, the control circuit 40 can eliminate the hard switching by causing the free-wheeling current in the reverse direction in the free-wheeling period to be 0. Furthermore, since the control circuit 40 can cause the number of body diodes through which the free-wheeling current in the forward direction in the free-wheeling period passes, to be one, the power loss can be reduced.

FIG. 12 is a diagram illustrating a sixth example of the switching state of the rectifier circuit 36 in the free-wheeling period. In the free-wheeling period, as an example, the control circuit 40 turns off the second switch element 74 and the fourth switch element 78 by setting the control signal (F) and the control signal (H) to logic L as illustrated in FIG. 12. Further, in the free-wheeling period, the control circuit 40 turns on the first switch element 72 and the third switch element 76 by setting the control signal (E) and the control signal (G) to logic H.

As a result, in the free-wheeling period, the control circuit 40 can cause the free-wheeling current in the forward direction in the direction from the second intermediate terminal 70 to the first intermediate terminal 68 to flow via the body diode of the second switch element 74 and the first switch element 72 in the ON state, or the body diode of the fourth switch element 78 and the third switch element 76 in the ON state. Note that the free-wheeling current in the forward direction theoretically flows while being distributed to two paths, but actually flows in one of the paths due to a difference in balance of resistance values.

Then, the control circuit 40 can block the free-wheeling current in the reverse direction from the first intermediate terminal 68 to the second intermediate terminal 70 by the rectification function of the body diodes of the second switch element 74 and the fourth switch element 78. By performing such switching, the control circuit 40 can eliminate the hard switching by causing the free-wheeling current in the reverse direction in the free-wheeling period to be 0. Furthermore, since the control circuit 40 can cause the number of body diodes through which the free-wheeling current in the forward direction in the free-wheeling period passes, to be one, the power loss can be reduced.

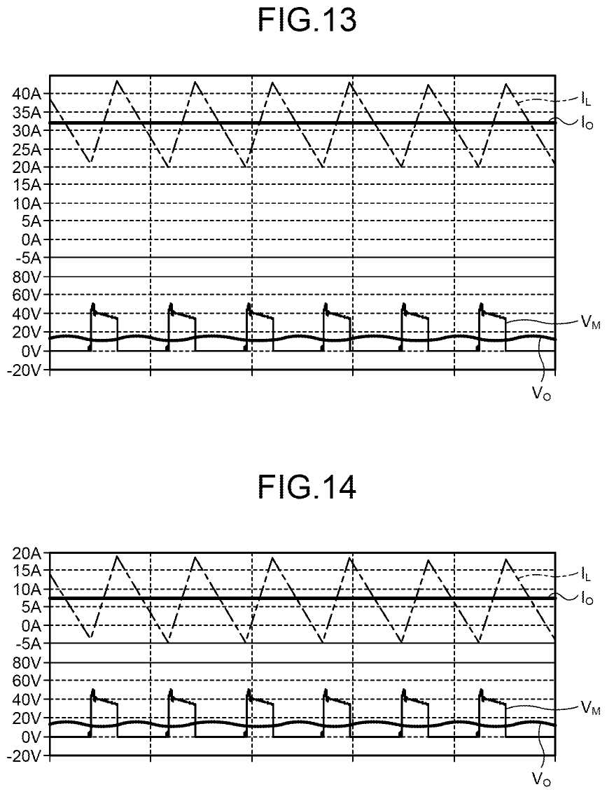

FIG. 13 is a schematic waveform chart of a voltage and a current when synchronous switching is performed in the transmission period and all of the switch elements are turned on in the free-wheeling period in a state where a heavy load is connected.

Reference sign Io indicates the output current. Reference sign Vo indicates the output voltage. Reference sign I_{L} indicates a current flowing through the smoothing inductor 80. Reference sign V_{M} indicates the rectified voltage applied between the first intermediate terminal 68 and the second intermediate terminal 70.

The rectified voltage (V_{M}) becomes a positive voltage in the transmission period and becomes 0 in the free-wheeling period. The smoothing inductor current (I_{L}) increases in the transmission period and decreases in the free-wheeling period.

The output voltage (Vo) has a value obtained by averaging the rectified voltage (V_{M}). The output current (Io) has a value obtained by averaging the smoothing inductor current (I_{L}).

In the example of FIG. 13, a heavy load is connected, the output current (Io) is about 30 A, and the smoothing inductor current (I_{L}) increases or decreases from about 20 A to about 40 A. Therefore, when a heavy load is connected, the smoothing inductor current (I_{L}) does not have a negative value during the free-wheeling period. That is, when a heavy load is connected, the DC-DC converter 10 does not cause the free-wheeling current in the reverse direction to flow.

FIG. 14 is a schematic waveform chart of the voltage and the current when synchronous switching is performed in the transmission period and all of the switch elements are turned on in the free-wheeling period in a state where a light load is connected.

In the example of FIG. 14, a light load is connected, and the output current (Io) is about 5 A. In this case, the smoothing inductor current (I_{L}) increases or decreases from about −5 A to about 15 A.

In a case of the example of FIG. 14, the smoothing inductor current (I_{L}) includes a period in which the smoothing inductor current (I_{L}) has a negative value. In this period, the free-wheeling current in the reverse direction flows through the rectifier circuit 36. Therefore, when switching is performed in a state where such a free-wheeling current in the reverse direction flows, the rectifier circuit 36 is subjected to hard switching and generates a large switching loss.

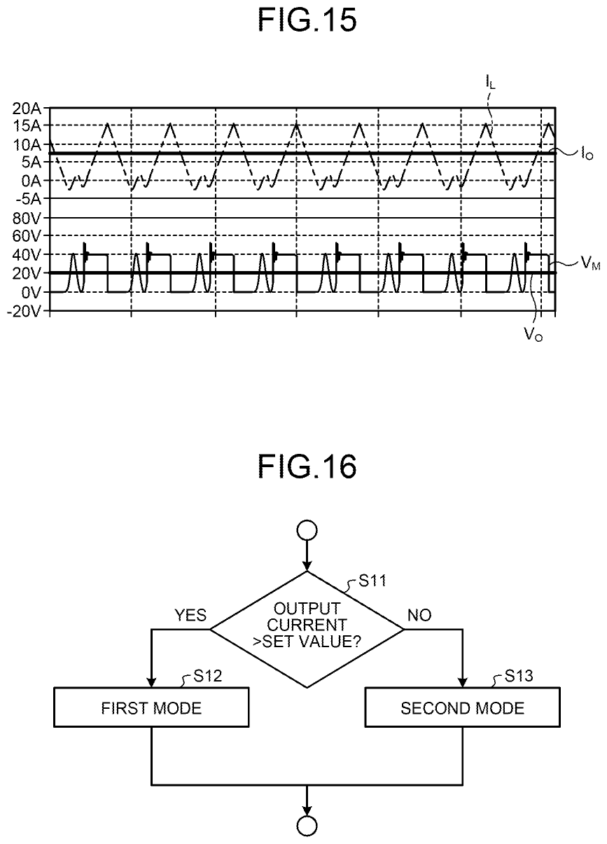

FIG. 15 is a schematic waveform chart of a voltage and a current of the DC-DC converter 10 according to the present embodiment in a state where a light load is connected.

The control circuit 40 according to the present embodiment prevents a reverse flow by a diode so that the smoothing inductor current (I_{L}) in the reverse direction does not flow in the free-wheeling period. Further, the control circuit 40 according to the present embodiment performs switching of the first switch element 72, the second switch element 74, the third switch element 76, and the fourth switch element 78 such that the free-wheeling current in the forward direction flows through the rectifier circuit 36 in the free-wheeling period.

Therefore, as illustrated in FIG. 15, the smoothing inductor current (I_{L}) does not have a negative value even in a state where a light load is connected. Therefore, the control circuit 40 can efficiently perform power conversion without causing hard switching.

FIG. 16 is a flowchart illustrating setting processing for a mode. For example, the control circuit 40 may periodically execute the setting processing for the mode illustrated in FIG. 16.

First, in S11, the control circuit 40 determines whether or not the output current (Io) output from the smoothing circuit 38 is larger than a set value set in advance. When the output current (Io) is larger than the set value (Yes in S11), the processing proceeds to S12. Then, in S12, the control circuit 40 sets itself to a first mode. When the output current (Io) is not larger than the set value (No in S11), the process proceeds to S13. Then, in S13, the control circuit 40 sets itself to a second mode.

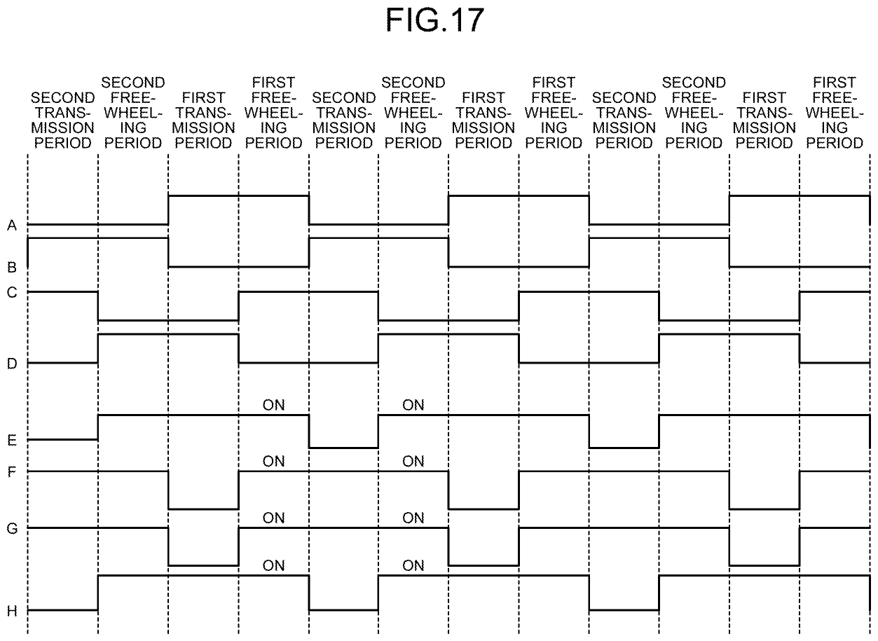

FIG. 17 is a timing chart of the control signals in the first mode.

When set to the first mode, the control circuit 40 performs switching of the rectifier circuit 36 in synchronization with the DC-AC conversion circuit 32 such that the positive side of the secondary AC voltage is applied to the first intermediate terminal 68 and the negative side of the secondary AC voltage is applied to the second intermediate terminal 70 in the transmission period. Specifically, in the first transmission period, the control circuit 40 sets the control signal (E) and the control signal (H) to logic H and sets the control signal (F) and the control signal (G) to logic L. In addition, in the second transmission period, the control circuit 40 sets the control signal (F) and the control signal (G) to logic H and sets the control signal (E) and the control signal (H) to logic L.

When set to the first mode, the control circuit 40 turns on the first switch element 72, the second switch element 74, the third switch element 76, and the fourth switch element 78 by setting all of the control signal (E), the control signal (F), the control signal (G), and the control signal (H) to logic H in the free-wheeling period.

When a heavy load is connected, the free-wheeling current does not have a negative value. That is, when the output current (Io) is larger than the set value, the free-wheeling current in the reverse direction does not flow through the rectifier circuit 36. Therefore, when a heavy load is connected, the DC-DC converter 10 does not cause a switching loss due to hard switching. Therefore, when the output current (Io) is larger than the set value, the DC-DC converter 10 eliminates a power loss due to the body diode and enables efficient power conversion by turning on all of the first switch element 72, the second switch element 74, the third switch element 76, and the fourth switch element 78.

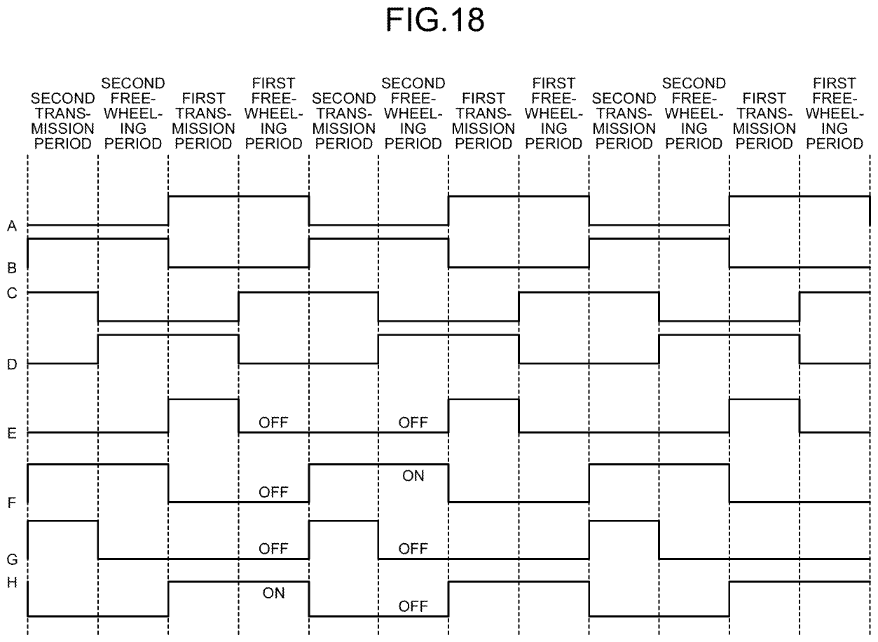

FIG. 18 is a timing chart of the control signals in the second mode. When set to the second mode, the control circuit 40 executes the same control as that in the first mode on the rectifier circuit 36 in the transmission period.

When set to the second mode, the control circuit 40 performs switching of the rectifier circuit 36 in the free-wheeling period such that a current flows through only one body diode in the rectifier circuit 36 in the direction from the second intermediate terminal 70 to the first intermediate terminal 68, and a current is blocked by the rectification function of the body diode in the rectifier circuit 36 in the direction from the first intermediate terminal 68 to the second intermediate terminal 70.

For example, in the example of FIG. 18, in the first free-wheeling period, the control circuit 40 sets the control signal (H) to logic H and sets the control signal (E), the control signal (F), and the control signal (G) to logic L to turn on the fourth switch element 78 and turn off the first switch element 72, the second switch element 74, and the third switch element 76. In addition, in the example of FIG. 18, in the second free-wheeling period, the control circuit sets the control signal (F) to logic H and sets the control signal (E), the control signal (G), and the control signal (H) to logic L to turn on the second switch element 74 and turn off the first switch element 72, the third switch element 76, and the fourth switch element 78.

Note that when set to the second mode, the control circuit 40 may perform switching of the first switch element 72, the second switch element 74, the third switch element 76, and the fourth switch element 78 in another switching pattern other than the switching pattern of FIG. 18 in the free-wheeling period.

When set to the second mode, the control circuit 40 can block the free-wheeling current in the reverse direction by the diode by controlling the rectifier circuit 36 in this manner only in a case where there is a possibility that the free-wheeling current in the reverse direction in the free-wheeling period flows.

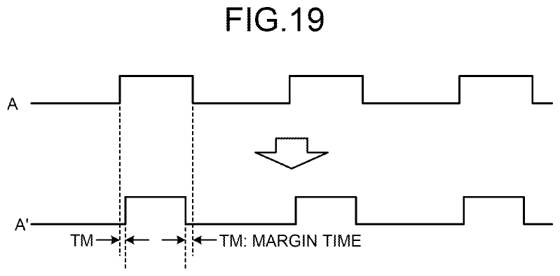

FIG. 19 is a diagram illustrating a waveform of a reference signal for generating a control signal on a secondary side. The control circuit 40 may generate control signals (E to H) on the secondary side for controlling the rectifier circuit 36 in synchronization with the control signals (A to D) on a primary side for controlling the DC-AC conversion circuit 32. In this case, the control circuit 40 performs switching of the rectifier circuit 36 so as not to connect the secondary coil 62 to the smoothing circuit 38 in a period in which no voltage is generated from the secondary coil 62 of the transformer 34.

For example, the control circuit 40 switches the rectifier circuit 36 from the free-wheeling period to the transmission period at a timing delayed by a margin time of a predetermined time from a timing at which the DC-AC conversion circuit 32 switches from the free-wheeling period to the transmission period. In addition, the control circuit switches the rectifier circuit 36 from the transmission period to the free-wheeling period at a timing earlier by the margin time of the predetermined time from a timing at which the DC-AC conversion circuit 32 switches from the transmission period to the free-wheeling period.

For example, when a logic circuit generates the control signals (E to H) on the secondary side on the basis of the control signals (A to D) on the primary side, the control circuit 40 generates a corrected control signal (A′) obtained by correcting the control signal (A) on the primary side as illustrated in FIG. 19. Specifically, the control circuit 40 generates the corrected control signal (A′) in which the timing of switching from logic L to logic H is delayed by the margin time and the timing of switching from logic H to logic L is advanced by the margin timing. In addition, the control circuit 40 similarly generates corrected control signals (B′, C′, D′) for the other control signals (B, C, D) on the primary side. Then, the control circuit 40 generates the control signals (E to H) on the secondary side by the logic circuit on the basis of the corrected control signals (A′ to D′).

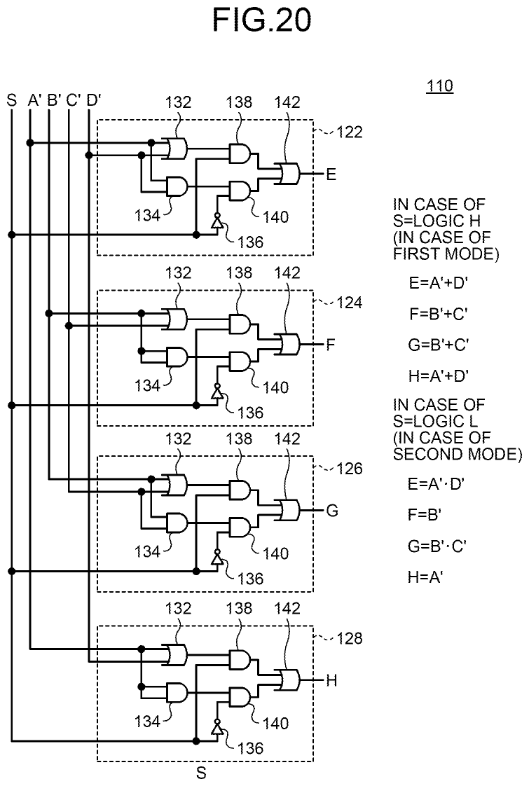

FIG. 20 is a diagram illustrating a configuration of a signal generating circuit 110, which is the logic circuit for generating the control signals (E to H) on the secondary side. The control circuit 40 may include the signal generating circuit 110, which is the logic circuit for generating the control signals (E to H) on the secondary side.

The signal generating circuit 110 receives a mode signal (S) and the four corrected control signals (A′ to D′). The mode signal (S) indicates that operation is performed in the first mode in a case of logic H. The mode signal (S) indicates that operation is performed in the second mode in a case of logic L.

The signal generating circuit 110 includes an E generating circuit 122, an F generating circuit 124, a G generating circuit 126, and an H generating circuit 128.

The E generating circuit 122 includes a first OR circuit 132, a first AND circuit 134, an inverting circuit 136, a second AND circuit 138, a third AND circuit 140, and a second OR circuit 142.

The first OR circuit 132 outputs a logical sum of A′ and D′. The first AND circuit 134 outputs a logical product of A′ and D′. The inverting circuit 136 inverts S. The second AND circuit 138 outputs a logical product of the output signal of the first OR circuit 132 and S. The third AND circuit 140 outputs a logical product of the output signal of the first AND circuit 134 and the output signal of the inverting circuit 136. The second OR circuit 142 outputs a logical sum of the output signal of the second AND circuit 138 and the output signal of the third AND circuit 140.

Such an E generating circuit 122 outputs the logical sum of A′ and D′ as the control signal (E) on the secondary side when S is logic H, that is, in a case of the first mode. In addition, the E generating circuit 122 outputs the logical product of A′ and D′ as the control signal (E) on the secondary side when S is logic L, that is, in a case of the second mode.

The F generating circuit 124 has the same circuit configuration as the E generating circuit 122. However, a first OR circuit 132 included in the F generating circuit 124 outputs a logical sum of B′ and C′. A first AND circuit 134 included in the F generating circuit 124 outputs a logical product of B′ and B′.

Such an F generating circuit 124 outputs the logical sum of B′ and C′ as the control signal (F) on the secondary side when S is logic H, that is, in the case of the first mode. In addition, the F generating circuit 124 outputs B′ as the control signal (F) on the secondary side when S is logic L, that is, in the case of the second mode.

The G generating circuit 126 has the same circuit configuration as the E generating circuit 122. However, a first OR circuit 132 included in the G generating circuit 126 outputs a logical sum of B′ and C′. A first AND circuit 134 included in the G generating circuit 126 outputs a logical product of B′ and C′.

Such a G generating circuit 126 outputs the logical sum of B′ and C′ as the control signal (E) on the secondary side in the case of the first mode. In addition, the G generating circuit 126 outputs the logical product of B′ and C′ as the control signal (G) on the secondary side in the case of the second mode.

The H generating circuit 128 has the same circuit configuration as the E generating circuit 122. However, a first OR circuit 132 included in the H generating circuit 128 outputs the logical sum of A′ and D′. A first AND circuit 134 included in the H generating circuit 128 outputs a logical product of A′ and A′.

Such an H generating circuit 128 outputs the logical sum of A′ and D′ as the control signal (H) on the secondary side in the case of the first mode. In addition, the H generating circuit 128 outputs A′ as the control signal (H) on the secondary side in the case of the second mode.

The signal generating circuit 110 having the above configuration can generate the control signals (E to H) on the secondary side as illustrated in FIG. 17 in the first mode. In addition, the signal generating circuit 110 can generate the control signals (E to H) on the secondary side as illustrated in FIG. 18 in the second mode.

As described above, the DC-DC converter 10 according to the present embodiment switches the connection between the secondary coil 62 and the first intermediate terminal 68 and the connection between the secondary coil 62 and the second intermediate terminal 70 in the rectifier circuit 36 in synchronization with the switching of the DC-AC conversion circuit 32 such that the positive side of the secondary AC voltage is applied to the first intermediate terminal 68 and the negative side of the secondary AC voltage is applied to the second intermediate terminal 70 in the transmission period. As a result, the DC-DC converter 10 can eliminate the power loss in the transmission period.

Furthermore, the DC-DC converter 10 according to the present embodiment causes the rectifier circuit 36 to perform rectification by the diode such that a current flows from the first intermediate terminal 68 to the second intermediate terminal 70 via the rectifier circuit 36 and a current flows from the second intermediate terminal 70 to the first intermediate terminal 68 via the rectifier circuit 36 in the free-wheeling period. As a result, the DC-DC converter 10 can suppress the power loss due to the hard switching by causing the free-wheeling current in the reverse direction in the free-wheeling period, that is, the current flowing in the direction from the first intermediate terminal 68 to the second intermediate terminal 70 via the rectifier circuit 36 to be 0.

In addition, furthermore, since the DC-DC converter 10 according to the present embodiment causes the number of diodes through which the free-wheeling current in the forward direction, that is, the current flowing in the direction from the second intermediate terminal 70 to the first intermediate terminal 68 via the rectifier circuit 36 passes in the free-wheeling period, to be one, the power loss in the free-wheeling period can be reduced.

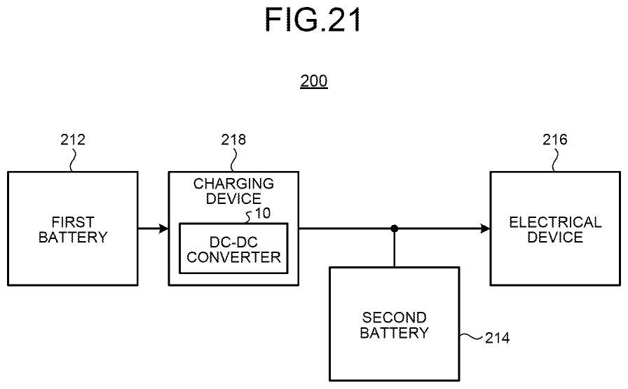

FIG. 21 is a diagram illustrating a configuration of a vehicle 200 to which the DC-DC converter 10 is applied. The vehicle 200 includes a first battery 212, a second battery 214, an electrical device 216, and a charging device 218.

The first battery 212 is, for example, a lithium ion battery, and is supplied with power from a charging stand or the like for an electric vehicle. The first battery 212 generates a DC voltage of, for example, about 360 V.

The second battery 214 is, for example, a lead-acid battery, and is charged by transferring power of the first battery 212. The second battery 214 generates a DC voltage of, for example, about 12 V.

The electrical device 216 is a device mounted on the vehicle 200. The electrical device 216 is operated by power output from the charging device 218 or power charged in the second battery 214. For example, the electrical device 216 is an in-vehicle computer, a power steering, a headlight, an air conditioner, or the like.

The charging device 218 includes the DC-DC converter 10 of either the first embodiment or the second embodiment. The charging device 218 extracts the power of the first battery 212, and charges the second battery 214 with the extracted power. For example, the DC-DC converter 10 included in the charging device 218 steps down the DC voltage generated from the first battery 212 and converts the DC voltage into a DC voltage chargeable to the second battery 214.

The vehicle 200 can travel by driving a motor with the power of the first battery 212. In addition, the vehicle 200 can drive the electrical device 216 with the power of the second battery 214 to perform various control and auxiliary operation of the vehicle 200.

Then, the vehicle 200 can efficiently perform power conversion with a small power loss in the DC-DC converter 10 in the charging device 218. As a result, the vehicle 200 can efficiently charge the second battery 214 with the power of the first battery 212.

In addition, the above exemplary embodiments are merely examples of implementation in implementing the present disclosure, and the technical scope of the present disclosure should not be interpreted in a limited manner by these exemplary embodiments. That is, the present disclosure can be implemented in various forms without departing from the gist or main features of the present disclosure.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A DC-DC converter comprising:
a DC-AC conversion circuit that converts a DC input voltage into a primary AC voltage by performing switching to reverse polarity of the DC input voltage;
a transformer including a primary coil to which the primary AC voltage is applied and a secondary coil magnetically coupled to the primary coil, the transformer generating a secondary AC voltage at the secondary coil;
a rectifier circuit that outputs a rectified voltage obtained by full-wave rectifying the secondary AC voltage;
a smoothing circuit that outputs a DC output voltage obtained by smoothing the rectified voltage; and
a control circuit that controls operation of the DC-AC conversion circuit and the rectifier circuit, wherein
the control circuit causes the rectifier circuit to perform rectification by a diode such that, in a free-wheeling period in which power of the input voltage is not transmitted from the DC-AC conversion circuit to the transformer, a current does not flow via the rectifier circuit from a first intermediate terminal, which is one intermediate terminal connected to the smoothing circuit, to a second intermediate terminal connected to the smoothing circuit and opposite to the first intermediate terminal, and a current flows via the rectifier circuit from the second intermediate terminal to the first intermediate terminal.

2. The DC-DC converter according to claim 1, wherein
the control circuit switches a connection between the secondary coil and the first intermediate terminal and a connection between the secondary coil and the second intermediate terminal in the rectifier circuit in synchronization with switching of the DC-AC conversion circuit, such that a positive side of the secondary AC voltage is applied to the first intermediate terminal and a negative side of the secondary AC voltage is applied to the second intermediate terminal in a transmission period in which the power of the input voltage is transmitted from the DC-AC conversion circuit to the transformer.

3. The DC-DC converter according to claim 2, wherein
the rectifier circuit includes:
a first switch element connected between a first transformer output terminal connected to one terminal of the secondary coil and the first intermediate terminal;
a second switch element connected between the second intermediate terminal and the first transformer output terminal;
a third switch element connected between a second transformer output terminal connected to the secondary coil on a side opposite to the terminal to which the first transformer output terminal is connected, and the first intermediate terminal; and
a fourth switch element connected between the second intermediate terminal and the second transformer output terminal.

4. The DC-DC converter according to claim 3, wherein
each of the first switch element, the second switch element, the third switch element, and the fourth switch element conducts when turned on, and functions as a diode when turned off,
in the first switch element, an anode of the diode is connected to the first transformer output terminal and a cathode of the diode is connected to the first intermediate terminal,
in the second switch element, an anode of the diode is connected to the second intermediate terminal and a cathode of the diode is connected to the first transformer output terminal,
in the third switch element, an anode of the diode is connected to the second transformer output terminal and a cathode of the diode is connected to the first intermediate terminal, and
in the fourth switch element, an anode of the diode is connected to the second intermediate terminal and a cathode of the diode is connected to the second transformer output terminal.

5. The DC-DC converter according to claim 4, wherein
the control circuit
turns on the first switch element and the fourth switch element and turns off the second switch element and the third switch element in a first transmission period in which a voltage higher than that of the second transformer output terminal is generated from the first transformer output terminal in the transmission period, and
turns on the second switch element and the third switch element and turns off the first switch element and the fourth switch element in a second transmission period in which a voltage higher than that of the first transformer output terminal is generated from the second transformer output terminal in the transmission period.

6. The DC-DC converter according to claim 4, wherein
in the free-wheeling period,
the first switch element and the third switch element are turned off and at least one of the second switch element and the fourth switch element is turned on, or
the second switch element and the fourth switch element are turned off and at least one of the first switch element and the third switch element is turned on.

7. The DC-DC converter according to claim 4, wherein
when set to a first mode, the control circuit turns on the first switch element, the second switch element, the third switch element, and the fourth switch element in the free-wheeling period, and
when set to a second mode, in the free-wheeling period, the control circuit
turns off the first switch element and the third switch element and turns on at least one of the second switch element and the fourth switch element, or
turns off the second switch element and the fourth switch element and turns on at least one of the first switch element and the third switch element.

8. The DC-DC converter according to claim 7, wherein
the control circuit sets itself to the first mode when an output current output from the smoothing circuit is larger than a set value set in advance, and sets itself to the second mode when the output current is not larger than the set value.

9. The DC-DC converter according to claim 3, wherein
each of the first switch element, the second switch element, the third switch element, and the fourth switch element is a metal-oxide-semiconductor field-effect (MOSFET).

10. A vehicle comprising
the DC-DC converter according to claim 1.
